(19) United States
(12) Patent Application Publication
(10) Pub. No.: US 2005/0056328 A1
(43) Pub. Date: Mar. 17, 2005

(54) Hydraulic pressure regulating device for variable line pressure control

(76) Inventors: Jae Hee Hong, Seoul (KR); Ki Been Lim, Suwon-city (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/747,913

(22) Filed: Dec. 29, 2003

(30) Foreign Application Priority Data
Sep. 16, 2003 (KR) 10-2003-0064055

(51) Int. Cl. F15B 13/042

(52) U.S. Cl. 137/625.66

(57) ABSTRACT

A hydraulic pressure regulating device for variable line pressure control is provided which comprises a valve housing, a sleeve, an adjustment screw assembly, a spring, and a valve spool. The valve housing defines a chamber therein. The sleeve is disposed in the chamber and is provided with a spring-receiving hole in one side thereof, and a projection portion is formed on an outer circumference of the sleeve to contact an inner surface of the valve housing. The adjustment screw assembly is configured to be able to adjust a position of the sleeve, and the sleeve is supported by the adjust screw assembly. One end of the spring is inserted into the spring-receiving hole such that the spring is supported by the sleeve. The valve spool is disposed in the chamber to be driven by a hydraulic pressure supplied into the chamber, and it is elastically supported by the spring.

### CROSS-REFERENCE TO RELATED APPLICATIONS

This application claims priority of Korean Application No. 10-2003-0064055, filed on Sep. 16, 2003.

### FIELD OF THE INVENTION

The present invention relates to a hydraulic pressure regulating device for variable line pressure control for an automatic transmission of a vehicle.

### BACKGROUND OF THE INVENTION

Generally, a full variable line pressure control valve body of an automatic transmission includes a normal hydraulic circuit of an automatic transmission, and a variable force solenoid (VFS) for controlling a regulator valve. An object of full variable line pressure control is to form an optimal line pressure through control of the variable force solenoid.

In a conventional hydraulic system of an automatic transmission, the line pressure is regulated to be 10.5 bar in a first speed or in a second speed, and it is regulated to be 8.5 bar in a third speed to a fifth speed. However, in the full variable line pressure control, the line pressure can be changed from a minimum value to a maximum value in response to a vehicle speed. The line pressure is controlled to be lower at a lower speed and to be high at a high speed, so that a fuel economy can be increased.

In a typical prior art hydraulic pressure regulating device a sleeve blocks an inflow of hydraulic pressure. A valve spool is biased by a coil spring that is supported by the sleeve. An adjustment screw assembly adjusts the position of the sleeve so that a biasing force acting on the valve spool by the coil spring can be regulated.

However, the prior pressure regulating device has a problem in that there is a limitation in regulating the position of the sleeve, and the hydraulic pressure cannot be effectively sealed by the sleeve.

The information disclosed in this Background of the Invention section is only for enhancement of understanding of the background of the invention, and should not be taken as an acknowledgement or any form of suggestion that this information forms the prior art that is already known to a person skilled in the art.

### SUMMARY OF THE INVENTION

Embodiments of the present invention provide a hydraulic pressure regulating device that can be easily manufactured and can effectively regulate the line pressure.

In a preferred embodiment of the present invention, the hydraulic pressure regulating device for variable line pressure control comprises a valve housing, a sleeve, an adjustment screw assembly, a spring, and a valve spool. The valve housing defines a chamber therein. The sleeve is disposed in the chamber and is provided with a spring-receiving hole in one side thereof, and a projection portion is formed on an outer circumference of the sleeve to contact an inner surface of the valve housing. The adjustment screw assembly is configured to be able to adjust a position of the sleeve, and the sleeve is supported by the adjustment screw assembly. One end of the spring is inserted into the spring-receiving hole such that the spring is supported by the sleeve. The valve spool is disposed in the chamber to be driven by hydraulic pressure supplied into the chamber, and it is elastically supported by the spring.

It is preferable that the projection portion is formed on the outer circumference of a portion of the sleeve where the spring-receiving hole is formed.

### BRIEF DESCRIPTION OF THE DRAWINGS

The accompanying drawings, which are incorporated in and constitute a part of the specification, illustrate an embodiment of the invention, and, together with the description, serve to explain the principles of the invention, where:

FIG. 1 is a hydraulic pressure regulating device according to an embodiment of the present invention.

### DETAILED DESCRIPTION OF THE PREFERRED EMBODIMENTS

Hereinafter, a preferred embodiment of the present invention will be described in detail with reference to the accompanying drawing. A hydraulic pressure regulating device according to a preferred embodiment of the present invention is a device for full variable line pressure control of an automatic transmission.

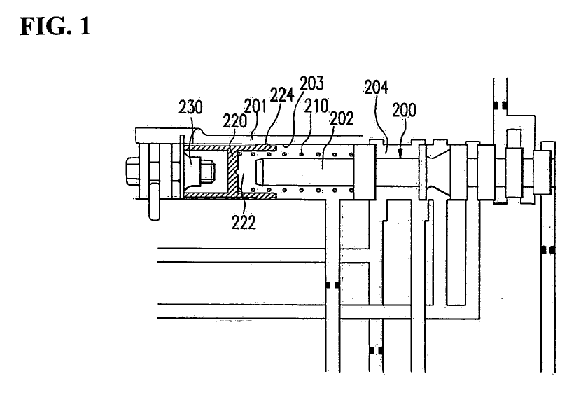

As shown in FIG. 1, the hydraulic pressure regulating device according to a preferred embodiment of the present invention comprises a valve spool 200, a spring 210, a sleeve 220, and an adjustment screw assembly 230. The valve spool 200, the spring 210, the sleeve 220, and the adjustment screw assembly 230 are disposed within a chamber 204 defined by a valve housing 201.

The valve housing 201 is provided with at least one input port and at least one output port, and the valve spool 200 is provided with at least one valve land. The valve spool 200 is slidably disposed within the chamber 204, so that a flow of hydraulic pressure can be regulated.

A spring-receiving hole 222 is formed in one side of the sleeve 220, and one end of the spring 210 is inserted into the spring-receiving hole 222, so that the spring 210 is supported by the sleeve 220. The other end of the sleeve 220 is supported by the adjustment screw assembly 230. Therefore, if a position of the adjustment screw assembly 230 is regulated according to its rotation, a position of the sleeve 220 is also changed. Consequently, a change of the position of the sleeve 220 causes a change of a compression degree of the spring 210, so that a force transmitted to the valve spool 200 can be regulated.

A projection portion 224 is formed at an outer circumference of the sleeve 220 for sealing. The projection portion 224 is formed to contact an inner surface 203 of the valve housing 201. Therefore, the projection portion 224 seals a portion of the chamber 204 where the valve spool 200 is positioned from the other portion of the chamber 204.

As shown in FIG. 1, one end (rightward end in the figure) of the spring 210 is supported by the valve spool 200. The spring 210 is supported by a valve land of the valve spool 200. Consequently, the valve spool 200 is elastically supported by the spring 210 against the sleeve 220.

The valve spool 200 is therefore urged to move in a rightward direction in the figure by a force transmitted from the spring 210, and at the same time, it is urged to move in a leftward direction by hydraulic pressure supplied into the valve housing 201. That is, the valve spool 200 is urged to move in opposite directions by the spring 210 and the hydraulic pressure, thereby maintaining an equilibrium state.

In a further preferred embodiment of the present invention, the sleeve 220 seals a variable solenoid control pressure, and an adjusting range of the adjustment screw assembly 230 is twice that of a conventional hydraulic pressure regulating device. Correspondingly, the sleeve 220 has a suitable shape for natural moving in the valve housing 201, and the adjustment screw assembly 230 has a corresponding structure.

If the adjusting range of the adjustment screw assembly 230 is doubled, the moving distance of the sleeve 220 is also doubled. Therefore, the inner surface 204 of the valve housing 210 must be precisely manufactured, and the length of the chamber 204 of the valve housing 201 must be substantially increased, so that a manufacturing process becomes complicated.

To solve the above problem, the sleeve 220 of the hydraulic pressure regulating device according to an embodiment of the present invention has a shape that makes it possible to reduce a length of the inner surface 204 that must be precisely manufactured while the length of the valve spool 200 is maintained.

As shown in FIG. 1, in this embodiment, the diameter of shaft 202 of the valve spool 200 and the diameter of the spring 210 are decreased, so that the shaft 202 and the spring 210 are inserted into the spring-receiving hole 222.

Lengths of the adjustment screw assembly 230 and the sleeve 220 are increased according to the increased adjusting range of the adjustment screw assembly 230. Furthermore, the projection portion 224 is positioned to be as near as possible to the valve spool 200, so that a length of the inner surface 203 that must be precisely manufactured can be decreased.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

As stated in the above, according to an embodiment of the present invention, the shapes of the sleeve and the adjustment screw assembly are changed so that a length of the inner surface of the valve housing that must be precisely manufactured can be decreased. Therefore, productivity can be improved, and manufacturing time and manufacturing cost can be reduced.

Furthermore, because the adjusting range of the adjustment screw assembly is increased, the line pressure can be more effectively regulated.

1. A hydraulic pressure regulating device for variable line pressure control, comprising:
a valve housing defining a chamber therein;
a sleeve disposed in the chamber and provided with a spring-receiving hole in one side thereof, a projection portion being formed on an outer circumference of the sleeve to contact an inner surface of the valve housing;
an adjustment screw assembly configured to adjust a position of the sleeve, the sleeve being supported by the adjustment screw assembly;
a spring, one end of which is inserted into the spring-receiving hole such that the spring is supported by the sleeve; and
a valve spool disposed in the chamber to be driven by hydraulic pressure supplied into the chamber, the valve spool being elastically supported by the spring.

2. The hydraulic pressure regulating device of claim 1, wherein the projection portion is formed on the outer circumference of a portion of the sleeve where the spring-receiving hole is formed.
